(19) United States
(12) Patent Application Publication
(10) Pub. No.: US 2026/0156418 A1
(43) Pub. Date: Jun. 4, 2026

(54) Loudspeaker

(71) Applicant: AAC Microtech (Changzhou) Co., Ltd., Changzhou City (CN)

(72) Inventors: Yao Hui, Changzhou (CN); Ruyang Wang, Changzhou (CN); Weimin Chen, Changzhou (CN)

(21) Appl. No.: 19/340,915

(22) Filed: Sep. 26, 2025

Related U.S. Application Data
(63) Continuation of application No. PCT/CN2024/136295, filed on Dec. 3, 2024.

(51) Int. Cl. H04R 9/06; H01F 1/12; H04R 9/02

(52) U.S. Cl. CPC H04R 9/06; H01F 1/12; H04R 9/025; H04R 2209/024

(57) ABSTRACT

Disclosed is a loudspeaker, including: a vibration system; a magnetic circuit system comprising a magnetic basket, a central magnet fixed to the magnetic basket, and a peripheral magnet fixed to the magnetic basket and disposed surrounding the central magnet. Compared with conventional technologies, the obliquely magnetized peripheral magnet can extend the lengths of effective magnetic field lines, equivalent to increasing the thickness of the peripheral magnet; meanwhile, fitting between the central special-shaped magnet and the peripheral special-shaped magnet achieves non-linear BL control; the loudspeaker described herein increases the total magnetic energy product via the special-shaped magnets, which increases the loudspeaker BL and alleviates BL non-linearity.

### FIELD

The disclosure relates to an acoustic device, and more particularly relates to a loudspeaker.

### BACKGROUND

With the advent of the mobile Internet era, smart mobile devices have more and more popular. To enrich entertainment functions of the mobile devices, audio-playing loudspeakers are also extensively applied in such devices; in addition, due to miniaturization of smart devices, the loudspeakers need also to be miniaturized while guaranteeing their acoustic functions.

An existing loudspeaker would comprise a vibration system comprising a voice coil and a magnetic circuit system disposed surrounding the voice coil; the magnetic circuit system comprises a primary magnet and a secondary magnet which are distributed at two sides of the voice coil, respectively, the primary magnetic material and the secondary magnetic field being overlaid with a conductive soft magnetic material, the soft magnetic material serving to concentrate the magnetic field lines generated between the primary magnet and the secondary magnet to the voice coil.

However, the existing loudspeaker would be significantly distorted under a high amplitude. Main causes of the distortion include the electro-acoustic conversion coefficient BL and the vibration stiffness nonlinearity as a function of amplitude; moreover, due to the strong BL non-linearity of a cone-type loudspeaker, an existing improvement solution can hardly achieve a tradeoff between the BL value and the first/second-order coefficients of the BL curve, which leads to optimization difficulty.

In view of the above, it is desirable to provide a novel loudspeaker to solve the technical problem noted supra.

### SUMMARY

A loudspeaker is provided to improve BL non-linearity of magnets.

A loudspeaker described herein comprises:
a vibration system comprising a diaphragm and a voice coil driving the diaphragm to vibrate to create sound;
a magnetic circuit system comprising a magnetic basket, a central magnet fixed to the magnetic basket, and a peripheral magnet fixed to the magnetic basket and disposed surrounding the central magnet, the central magnet and the peripheral magnet being spaced apart to define a magnetic gap, the voice coil being inserted and suspended in the magnetic gap, wherein:
the central magnet comprises a central magnet body fixed to the magnetic basket and a central special-shaped magnet, the central special-shaped magnet being formed by an outer peripheral edge of the central magnet body projecting in a direction away from the magnetic basket; and the central magnet is magnetized in a direction parallel to a vibration direction of the vibration system;
the peripheral magnet comprises a peripheral magnet body fixed to the magnetic basket and a peripheral special-shaped magnet, the peripheral special-shaped magnet being formed by an outer peripheral edge of the peripheral magnet body projecting in a direction away from the magnetic basket; and a magnetization direction of the peripheral magnet and a magnetization direction of the central magnet have an included angle of greater than or equal to 90° and less than 180°.

Optionally, wherein the magnetic circuit system further comprises a first soft magnet disposed overlaying one side of the central magnet body distal from the magnetic basket, and one side of the first soft magnet distal from the magnetic basket is in flush with one side of the central special-shaped magnet distal from the magnetic basket.

Optionally, wherein the magnetic circuit system further comprises a second soft magnet disposed overlaying the peripheral magnet body and attached to an inner peripheral edge of the peripheral special-shaped magnet, and one side of the second soft magnet distal from the magnetic basket is in flush with one side of the peripheral special-shaped magnet distal from the magnetic basket.

Optionally, wherein on a same section parallel to the vibration direction of the vibration system, a sectional area of the second soft magnet is less than a sectional area of the peripheral magnet.

Optionally, wherein one side of the second soft magnet distal from the voice coil is attached to the peripheral special-shaped magnet.

Optionally, wherein the magnetic circuit system further comprises an auxiliary magnet disposed at the side of the first soft magnet distal from the magnetic basket and a third soft magnet disposed overlaying one side of the auxiliary magnet distal from the magnetic basket, a magnetization direction of the auxiliary magnet being reverse to the magnetization direction of the central magnet.

Optionally, wherein a magnetic basket extension portion extending along the vibration direction is arranged at an outer periphery of the magnetic basket, the magnetic basket extension portion partially overlaying one side of the peripheral magnet distal from the voice coil.

Optionally, wherein the magnetic basket is made of a soft magnetic material.

Compared with conventional technologies, the loudspeaker according to the disclosure comprises: a vibration system comprising a diaphragm and a voice coil driving the diaphragm to vibrate to create sound; a magnetic circuit system comprising a magnetic basket, a central magnet fixed to the magnetic basket, and a peripheral magnet fixed to the magnetic basket and disposed surrounding the central magnet; the central magnet comprises a central magnet body fixed to the magnet and a central special-shaped magnet formed by an outer peripheral edge of the central magnet body projecting in a direction away from the magnetic basket; the central magnet is magnetized along a direction parallel to a vibration direction of the vibration system; the peripheral magnet comprises a peripheral magnet body fixed to the magnetic basket and a peripheral special-shaped magnet formed by an outer peripheral edge of the peripheral magnet body projecting in a direction away from the magnetic basket; a magnetization direction of the peripheral magnet and a magnetization direction of the central magnet have an included angle of greater than or equal to 90° and less than 180°. In the structure noted supra, the obliquely magnetized peripheral magnet can extend the lengths of effective magnetic field lines, equivalent to increasing the thickness of the peripheral magnet; meanwhile, fitting between the central special-shaped magnet and the peripheral special-shaped magnet achieves non-linear BL control; compared with the conventional technologies, the loudspeaker described herein increases the total magnetic energy product via the special-shaped magnets, which increases the loudspeaker BL and alleviates BL non-linearity.

### BRIEF DESCRIPTION OF THE DRAWINGS

To better illustrate the technical solutions in the implementations of the disclosure, the drawings referred to in the description of the implementations will be introduced briefly. It is apparent that, the drawings illustrated herein only involve some implementations of the disclosure; to a person of normal skill in the art, other drawings may be derived based on these drawings without exercise of inventive work, in which:

FIG. 1 is a stereoscopic structural schematic diagram of a loudspeaker according to an implementation of the disclosure;

FIG. 2 is a sectional view along line A-A in FIG. 1;

FIG. 3 is a sectional view along line B-B in FIG. 1;

FIG. 4 is a stereoscopic structural exploded view of the loudspeaker according to an implementation of the disclosure;

FIG. 5 is a schematic diagram of magnetic flux directions of a magnetic circuit system of the loudspeaker according to an implementation of the disclosure;

FIG. 6 is a schematic diagram of magnetization directions of a magnetic circuit system of the loudspeaker according to an implementation of the disclosure;

FIG. 7 is a comparison diagram of loudspeaker BL(x) curves according to an implementation of the disclosure;

FIG. 8 is a schematic diagram of a magnetic circuit system of a loudspeaker according to a second implementation of the disclosure.

### DETAILED DESCRIPTION OF EMBODIMENTS

Hereinafter, the technical solutions in the implementations of the disclosure will be described in a clear and comprehensive manner with reference to the accompanying drawings; it is apparent that the implementations described herein are only some of the implementations of the disclosure, not all of them. All other implementations derived by a person of normal skill in the art based on the the implementations described herein without exercise of inventive work would fall within the scope of protection of the disclosure.

### First Implementation

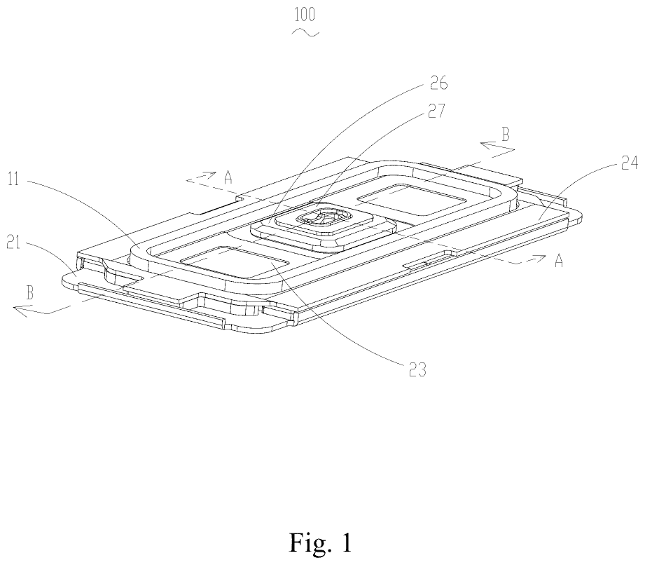

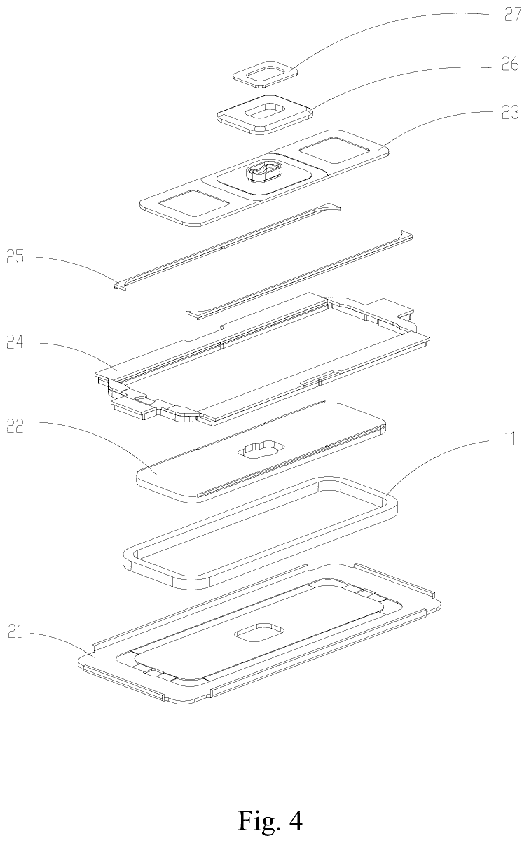

As illustrated in FIGS. 1-7, an implementation of the disclosure provides a loudspeaker 100, comprising:
a vibration system 1 comprising a diaphragm (not shown) and a voice coil 11 driving the diaphragm to vibrate to create sound;
a magnetic circuit system 2 comprising a magnetic basket 21, a central magnet 22 fixed to the magnetic basket 21, and a peripheral magnet 24 fixed to the magnetic basket 21 and disposed surrounding the central magnet 22, the central magnet 22 and the peripheral magnet 24 being spaced apart to define a magnetic gap, the voice coil 11 being inserted and suspended in the magnetic gap;
the central magnet 22 comprises a central magnet body 221 fixed to the magnetic basket 21 and a central special-shaped magnet 222, the central special-shaped magnet 222 being formed by an outer peripheral edge of the central magnet body 221 projecting in a direction away from the magnetic basket 21; and the central magnet 22 is magnetized in a direction parallel to a vibration direction of the vibration system 1;
the peripheral magnet 24 comprises a peripheral magnet body 241 fixed to the magnetic basket 21 and a peripheral special-shaped magnet 242, the peripheral special-shaped magnet 242 being formed by an outer peripheral edge of the peripheral magnet body 241 projecting in a direction away from the magnetic basket 21; and a magnetization direction of the peripheral magnet 24 and a magnetization direction of the central magnet 22 have an included angle of greater than or equal to 90° and less than 180°.

The magnetic circuit system 2 further comprises a first soft magnet 23 disposed overlaying one side of the central magnet body 221 distal from the magnetic basket 21, one side of the first soft magnet 23 distal from the magnetic basket 21 being in flush with one side of the central special-shaped magnet 22 distal from the magnetic basket 21.

The central special-shaped magnet 222 projecting from the central magnet body 221 is not overlaid by the soft magnet; this design may increase the magnetic flux passing through an upper half portion of the voice coil 11, which improves symmetricity of the BL curve and decreases the first-order coefficient of the BL(x) curve.

The magnetic circuit system 2 further comprises a second soft magnetic 25 disposed overlaying the peripheral magnet body 241 and attached to an inner peripheral edge of the peripheral special-shaped magnet 242, one side of the second soft magnet 25 distal from the magnetic basket 21 being in flush with one side of the peripheral special-shaped magnet 242 distal from the magnetic basket 21.

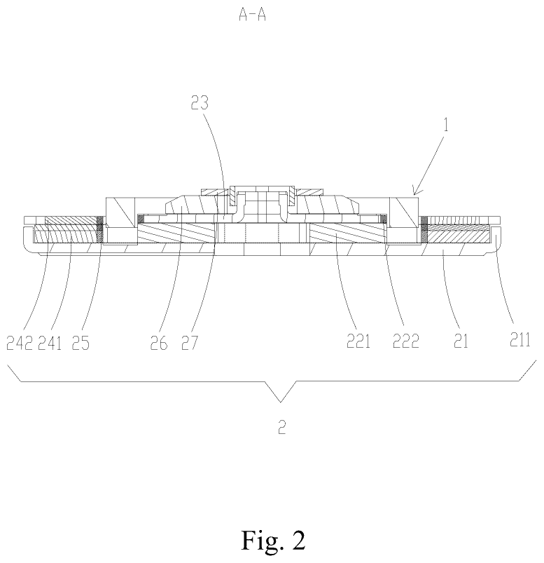

On a same section parallel to the vibration direction of the vibration system (as illustrated in FIG. 2), a sectional area of the second soft magnet 25 is less than a sectional area of the peripheral magnet 24.

Compared with a structure of an existing loudspeaker in which an entire piece of soft magnet is overlaid on the peripheral magnet, this implementation offers a smaller dimension ratio of the second soft magnet 25 to the obliquely magnetized peripheral magnet 24, which increases the dimension ratio of the magnets, thereby increasing the BL value while lowering the effect of the second-order coefficient of the BL(x) curve.

It may be understood that, the magnetic flux properties of the central special-shaped magnet 222 and the magnetic flux properties of the obliquely magnetized peripheral magnet 24 do not affect each other in this implementation. To optimize BL nonlinearity of the loudspeaker, the central special-shaped magnet 222 and the obliquely magnetized peripheral magnet 24 may be applied simultaneously or applied standalone dependent on actual needs.

In an alternative implementation of the disclosure, the structures of magnets in the central magnet 22 and the peripheral magnet 24 and the soft magnet are formed by a cutting process, and the magnets are combined by gluing or one-piece forming, whereby fine control of the BL and its non-linearity can be achieved.

The magnetic circuit system 2 further comprises an auxiliary magnet 26 disposed at one side of the first soft magnet 23 distal from the magnetic basket 21 and a third soft magnet 27 disposed overlaying one side of the auxiliary magnet 26 distal from the magnetic basket 21, a magnetization direction of the auxiliary magnet 26 being reverse to the magnetization direction of the central magnet 22.

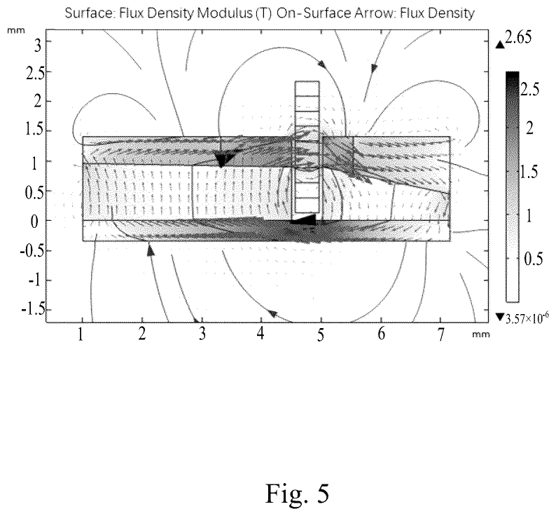

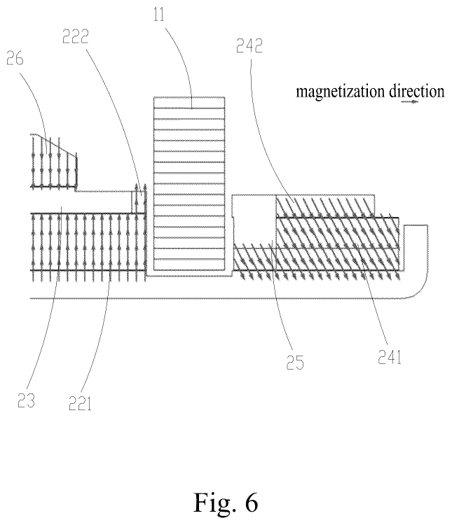

FIG. 6 illustrates magnetization directions of different magnet structures in the magnetic circuit system 2 according to an implementation of the disclosure. Specifically, the central magnet 22 in this implementation is magnetized in the direction parallel to the vibration direction of the vibration system 1 distal from the magnetic basket 21, and the peripheral magnet 24 is magnetized in a direction with an angle of greater than or equal to 90° and less than 180° relative to the magnetization direction of the central magnet 22 (i.e., the direction of the second soft magnet 25 pointing to an edge apex of the magnetic basket 21 in FIG. 6), and two faces of the second soft magnet 25 are attached to the peripheral magnet body 241 and the peripheral special-shaped magnet 242, respectively; by narrowing the soft magnet (the second soft magnet 25) in the magnetic circuit system 2, the magnetic field lines of the magnetic basket passing beneath the voice coil 11 are focused on the soft magnet (second soft magnet 25) close to the voice coil 11 as many as possible, thereby improving utilization of the magnetic energy product; in the sectional direction illustrated in FIG. 2 or FIG. 5, to control the directions of the magnetic field lines, the sectional area of the second soft magnet 25 is set smaller than the sectional area of the peripheral magnet 24; during an implementation process, considering uniformity of internal magnetic orientations of the magnet material, as illustrated in FIG. 6, dependent on different sizes of the peripheral magnet 24, a specific included angle between the magnetization direction of the peripheral magnet 24 and the magnetization direction of the central magnet is a weighted average of the products of the directions of the magnetic field lines and the path lengths.

It may be understood that, the magnetization directions illustrated in FIG. 6 are only exemplary settings. On the basis of the magnetization directions illustrated in FIG. 6, reverse settings of the magnetization directions of all magnet structures in the magnetic circuit system also achieve a same technical effect as that described in the implementation supra.

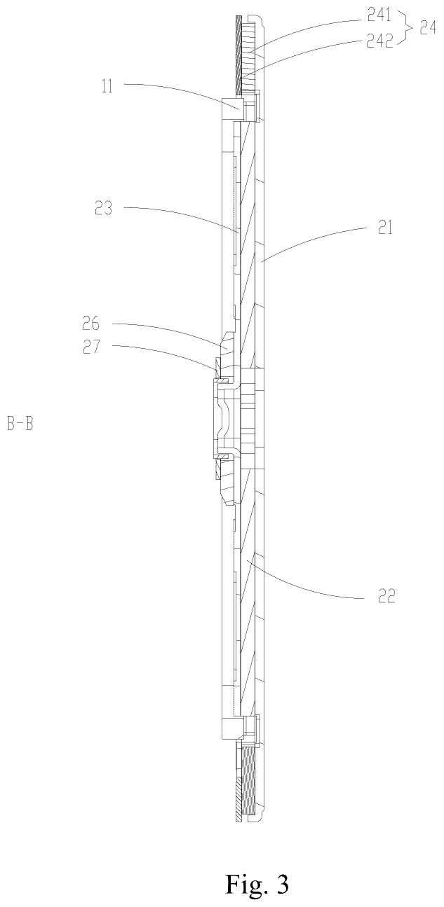

In this implementation, the second soft magnet 25 is attached to an inner peripheral edge of the peripheral special-shaped magnet 242 at a longer side of the peripheral magnet 24, while no second soft magnet 25 is attached to the inner peripheral edge of the peripheral special-shaped magnet 242 at a shorter side of the peripheral magnet 24 (as illustrated in FIGS. 2 and 3). It may be understood that, if a complete magnet structure is used without setting the second soft magnet 25 on the peripheral magnet 24, the magnetic circuit system 2 would have a better overall BL performance; but different settings of the longer side and shorter side of the peripheral magnet 24 in this implementation are determined dependent on actual application scenarios of the loudspeaker 100. In an alternative implementation of the disclosure, the second soft magnet 25 may also be attached to the inner peripheral edge of the peripheral special-shaped magnet 242 at the shorter side of the peripheral magnet 24, which achieves a same technical effect as that achieved by setting the second soft magnet 25 at the longer side.

A magnetic basket extension portion 211 extending in the vibration direction is arranged at an outer periphery of the magnetic basket 21, the magnetic basket extension portion 211 partially overlaying one side of the peripheral magnet 24 distal from the voice coil 11.

The magnetic basket 21 is made of a soft magnetic material.

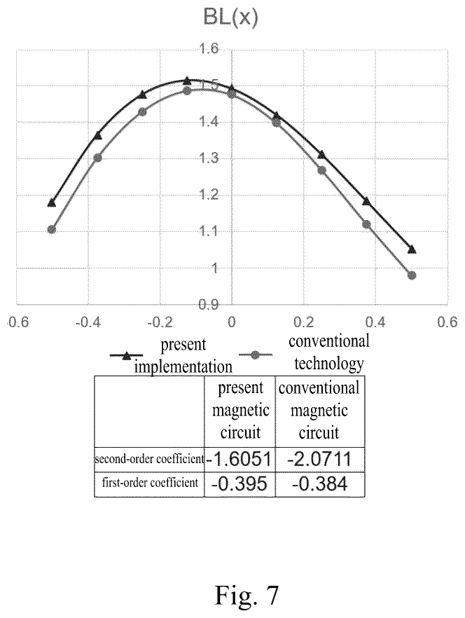

FIG. 7 illustrates a comparison between a BL(x) curve of the magnetic circuit system 2 comprising the obliquely magnetized peripheral magnet 24 according to this implementation and a BL(x) curve of a conventional magnetic circuit system including a peripheral magnet magnetized in a direction parallel to the voice coil vibration direction, which reveals that, the BL value of the magnetic circuit comprising the obliquely magnetized magnet is improved to a certain extent, so that the second-order coefficient of the BL(x) curve drops by 20% and the first-order coefficient of the BL(x) curve substantially has no change, which effectively alleviates the nonlinearity.

### Second Implementation

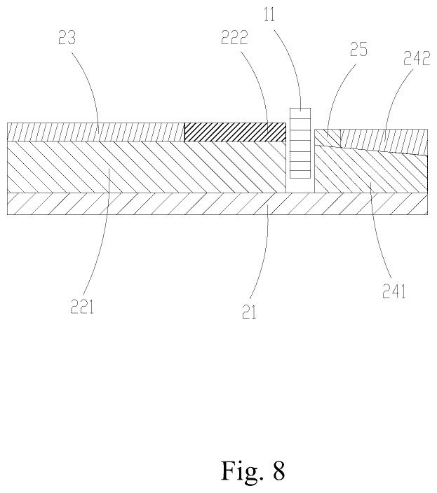

Different from the profiles of respective components of the magnetic circuit system 2 in the first implementation, FIG. 8 illustrates a schematic diagram of a magnetic circuit system 2 comprising a peripheral magnet body 241 of a special shape, a peripheral special-shaped magnet 242, and a second soft magnet 25. As noted supra in the first implementation of the disclosure, the structures of the magnets in the central magnet 22 and the peripheral magnet 24 and the soft magnets are formed by a cutting process and the magnets are combined by glueing or one-piece forming; in FIG. 8, the peripheral magnet body 241, the peripheral special-shaped magnet 242, and the second soft magnet 25 are cut with bevel surfaces different from the first implementation.

In conjunction with FIG. 5, the inclined fitting surfaces between respective magnets and the soft magnets allow for the magnetization directions of the magnets to be closer to the horizontal lines perpendicular to the vibration directions as well as the magnetic field lines, whereby fine control of the BL and its nonlinearity is achieved.

Compared with conventional technologies, the loudspeaker according to the disclosure comprises: a vibration system comprising a diaphragm and a voice coil driving the diaphragm to vibrate to create sound; a magnetic circuit system comprising a magnetic basket, a central magnet fixed to the magnetic basket, and a peripheral magnet fixed to the magnetic basket and disposed surrounding the central magnet; the central magnet comprises a central magnet body fixed to the magnet and a central special-shaped magnet formed by an outer peripheral edge of the central magnet body projecting in a direction away from the magnetic basket; the central magnet is magnetized along a direction parallel to a vibration direction of the vibration system; the peripheral magnet comprises a peripheral magnet body fixed to the magnetic basket and a peripheral special-shaped magnet formed by an outer peripheral edge of the peripheral magnet body projecting in a direction away from the magnetic basket; a magnetization direction of the peripheral magnet and a magnetization direction of the central magnet have an included angle of greater than or equal to 90° and less than 180°. In the structure noted supra, the obliquely magnetized peripheral magnet can extend the lengths of effective magnetic field lines, equivalent to increasing the thickness of the peripheral magnet; meanwhile, fitting between the central special-shaped magnet and the peripheral special-shaped magnet achieves non-linear BL control; compared with the conventional technologies, the loudspeaker described herein increases the total magnetic energy product via the special-shaped magnets, which increases the loudspeaker BL and alleviates BL non-linearity.

What have been described above are only example implementations of the disclosure. It is noted that, a person of normal skill in the art may make modifications without departing from the invention idea of the disclosure, while all of such modifications would fall into the scope of protection of the disclosure.

I/We claim:

1. A loudspeaker, comprising:
a vibration system comprising a diaphragm and a voice coil driving the diaphragm to vibrate to create sound;
a magnetic circuit system comprising a magnetic basket, a central magnet fixed to the magnetic basket, and a peripheral magnet fixed to the magnetic basket and disposed surrounding the central magnet, the central magnet and the peripheral magnet being spaced apart to define a magnetic gap, the voice coil being inserted and suspended in the magnetic gap, wherein:
the central magnet comprises a central magnet body fixed to the magnetic basket and a central special-shaped magnet, the central special-shaped magnet being formed by an outer peripheral edge of the central magnet body projecting in a direction away from the magnetic basket; and the central magnet is magnetized in a direction parallel to a vibration direction of the vibration system;
the peripheral magnet comprises a peripheral magnet body fixed to the magnetic basket and a peripheral special-shaped magnet, the peripheral special-shaped magnet being formed by an outer peripheral edge of the peripheral magnet body projecting in a direction away from the magnetic basket; and a magnetization direction of the peripheral magnet and a magnetization direction of the central magnet have an included angle of greater than or equal to 90° and less than 180°.

2. The loudspeaker according to claim 1, wherein the magnetic circuit system further comprises a first soft magnet disposed overlaying one side of the central magnet body distal from the magnetic basket, and one side of the first soft magnet distal from the magnetic basket is in flush with one side of the central special-shaped magnet distal from the magnetic basket.

3. The loudspeaker according to claim 1, wherein the magnetic circuit system further comprises a second soft magnet disposed overlaying the peripheral magnet body and attached to an inner peripheral edge of the peripheral special-shaped magnet, and one side of the second soft magnet distal from the magnetic basket is in flush with one side of the peripheral special-shaped magnet distal from the magnetic basket.

4. The loudspeaker according to claim 3, wherein on a same section parallel to the vibration direction of the vibration system, a sectional area of the second soft magnet is less than a sectional area of the peripheral magnet.

5. The loudspeaker according to claim 3, wherein one side of the second soft magnet distal from the voice coil is attached to the peripheral special-shaped magnet.

6. The loudspeaker according to claim 2, wherein the magnetic circuit system further comprises an auxiliary magnet disposed at the side of the first soft magnet distal from the magnetic basket and a third soft magnet disposed overlaying one side of the auxiliary magnet distal from the magnetic basket, a magnetization direction of the auxiliary magnet being reverse to the magnetization direction of the central magnet.

7. The loudspeaker according to claim 1, wherein a magnetic basket extension portion extending along the vibration direction is arranged at an outer periphery of the magnetic basket, the magnetic basket extension portion partially overlaying one side of the peripheral magnet distal from the voice coil.

8. The loudspeaker according to claim 1, wherein the magnetic basket is made of a soft magnetic material.
